(19) United States
(12) Patent Application Publication
(10) Pub. No.: US 2018/0325139 A1
(43) Pub. Date: Nov. 15, 2018

(54) CHEWING GUM WITH NATURAL ELASTOMER OR NATURAL ELASTOMER SYSTEM AND EDIBLE ADDITIVE

(71) Applicant: WM. WRIGLEY JR. COMPANY, Chicago, IL (US)

(72) Inventors: David R. PHILLIPS, Chicago, IL (US); Yang GAO, Chicago, IL (US); Steven P. SYNOSKY, Chicago, IL (US); April J. TACKETT, Chicago, IL (US); Neil A. WILLCOCKS, Chicago, IL (US)

(21) Appl. No.: 15/755,841

(22) PCT Filed: Aug. 26, 2016
(86) PCT No.: PCT/US16/49013

§ 371 Date: Feb. 27, 2018

Related U.S. Application Data
(60) Provisional application No. 62/212,385, filed on Aug. 31, 2015.

(51) Int. Cl. A23G 4/08; A23G 4/06

(52) U.S. Cl. CPC A23G 4/08; A23V 2002/00; A23G 4/068

(57) ABSTRACT

Chewing gums and chewing gum bases having at least one natural elastomer or natural elastomer system and at least one edible additive are disclosed.

### BACKGROUND OF THE INVENTION

The present invention relates to chewing gum and gum bases. More specifically, this invention relates to improved formulations for chewing gum bases and chewing gums having at least one natural elastomer or natural elastomer system as a constituent of the gum base and at least one edible additive as a constituent of the chewing gum as well.

Natural means existing in or caused by nature and not made or caused by human kind. Non-natural means created or caused by human kind. For example, natural products typically are obtained from plant, animal, and mineral sources.

Non-natural products are typically obtained by substantially modifying raw materials to contain properties not found in the original substance. For example, in order to produce polyisobutylene, it is necessary to refine natural petroleum by cracking purification and polymerization of monomers created in the cracking process.

In some cases, the non-natural product may be chemically very similar or identical to a natural material, however, it is not considered to be natural when derived in this manner.

In some cases, a natural ingredient or product may be refined using chemical processes. For example, an ingredient may be extracted from a plant or purified and isolated from other components it naturally accompanies. However, in such cases, the ingredient is chemically identical to the ingredient as contained in the plant.

For example, Rebaudioside A is produced by the stevia plant. While the plant may be used in its native form, it is often preferred to isolate out certain components such as Rebaudioside A. Under such circumstances, the Rebaudioside A is considered a natural product.

The fundamental components of chewing gum characteristically comprise a water-insoluble gum base portion and a water-soluble portion containing edible additives. The primary component of the present gum base is a natural elastomer or natural elastomer system which provides the characteristic chewy texture to the product. The gum base may include other ingredients which modify the chewing properties and/or may aid in processing of the product. These may include elastomer plasticizers, elastomer solvents, softeners, fillers, emulsifiers, resins, as well as colorants and antioxidants. The water-insoluble softeners used in gum bases include fats and waxes. All of these terms are well known by those skilled in the chewing gum art.

The water soluble portion of the chewing gum characteristically includes edible additives. The edible additives may include at least one bulking agent, such as a sweetener, and small amounts of secondary components such as flavors, high-intensity sweeteners, colorants, water-soluble softeners, gum emulsifiers, acidulants, sensates, or minimally processed plant materials. It will be understood that the water-soluble portion dissipates during chewing and the gum base is retained in the mouth throughout the chewing process.

The water-insoluble softeners typically used in gum bases include fats and waxes.

This invention is directed to novel chewing gum compositions which provide gum bases comprising at least one natural elastomer or elastomer system and at least one edible additive to provide the chewing gum with desirable qualities in texture and flavor.

### SUMMARY OF THE INVENTION

This invention relates to the formulation of chewing gums having at least one natural elastomer or natural elastomer system as a constituent of the gum base and at least one edible additive as a constituent of the chewing gum.

In some embodiments, the invention is directed to a chewing gum comprising a gum base comprising one or more natural elastomer(s) or natural elastomer system(s).

In some embodiments, the invention is directed to a chewing gum comprising at least one bulking agent such as a sweetener.

In some embodiments, the invention is directed to a chewing gum comprising at least one natural high intensity sweetener as an edible additive.

In some embodiments, the invention is directed to a chewing gum comprising at least one non-natural high intensity sweetener as an edible additive.

In some embodiments, the invention is directed to a chewing gum comprising at least one natural sweetener syrup as an edible additive.

In some embodiments, the invention is directed to a chewing gum comprising an editable additive, which can be at least one of fruit or vegetable preserves, fruit or vegetable jam, fruit or vegetable jelly, or minimally processed plant material.

In some embodiments, the invention is directed to a chewing gum comprising a combination of edible additives.

In some embodiments, the invention is directed to a chewing gum comprising a combination of natural elastomers or natural elastomer systems as gum base constituents.

In some embodiments, the invention is directed to a chewing gum comprising a combination of natural elastomers or natural elastomer systems as gum base constituents and edible additives.

In some embodiments, the invention is directed to a chewing gum having a gum base which is free of synthetic polymeric components.

In some embodiments, the invention is directed to a chewing gum which is free of non-natural high intensity sweeteners.

In some embodiments, the invention is directed to a chewing gum which is free of non-natural flavors.

### DESCRIPTION OF THE INVENTION

The present invention provides novel chewing gum bases and chewing gums. In accordance with the present invention, novel chewing gum bases and chewing gums are provided which comprise at least one natural elastomer and at least one edible additive.

A natural elastomer may refer to a natural elastomer or to a natural elastomer system. A natural elastomer is a polymer derived from at least one natural source with a low glass transition temperature (T_{g}). A natural elastomer system is a mixture of polymers derived from at least one natural source and comprises chains of elastomeric polymer and elastomer plasticizer. Elastomeric polymers are long chain molecules which have a low glass transition temperature (T_{g}). Elastomer plasticizers are chemically compatible with the elastomer polymers. The elastomer plasticizers are short chain molecules, lower in molecular weight than the elastomer polymers, and have a high glass transition temperature (T_{g}).

Low glass transition temperature (T_{g}) occurs when the temperature is below mouth temperature (i.e. 35° C.), preferably below standard room temperature (i.e. 20° C.), and more preferably below 0° C. High glass transition temperature occurs when the temperature is above mouth temperature (i.e. 35° C.), and preferably above 50° C.

The natural elastomer or natural elastomer system is a constituent of the insoluble gum base portion of the chewing gum. Natural elastomer or natural elastomer systems may be selected to allow marketing claims to be used in association with the chewing gums. That is, if it is desirable to promote a chewing gum as containing natural ingredients, natural elastomers or natural elastomer systems may be used alone, or in combination. The natural elastomer or natural elastomer system may include, but is not limited to, at least one elastomer plasticizer, natural rubber, natural latex, or any desired combination thereof. The natural elastomer systems include, but are not limited to, caoutchouc, caspi, couma macrocarpa (also called leche caspi or sorva), lechi, loquat (also called nispero), tunu, natural rubber (Hevea), jelutong, gutta, chicle, guayule, perillo, massaranduba balata, massaranduba chocolate, nispero, rosindinha, spruce gum, mastic gum, taraxacum kok-saghyz (TKS), in addition to other natural gum bases as listed in US 21 C.F.R. 172.615, or combinations thereof.

In some embodiments, constituents of the gum base may include, but are not limited to, other ingredients, or combinations of ingredients, which modify the chewing properties and/or aid in processing the chewing gum product. These include plasticizers, softeners, fillers, emulsifiers, resins, waxes, as well as colorants and antioxidants.

In some embodiments, a constituent of the gum base may include a combination or blend of natural waxes, such as candela, carnauba and beeswax, for example.

In some embodiments, at least one edible additive such as bulking agent(s) or bulk sweetener(s) may be provided in chewing gums described herein, alone or in combination, to provide sweetness, bulk, and texture to the chewing gum. Bulking agents may also be selected to allow marketing claims to be used in association with the chewing gums. In this respect, if it is desirable to promote a chewing gum as low calorie, low calorie bulking agents such as polydextrose may be used, or, if the chewing gum is desirably promoted as containing natural ingredients, natural bulking agents such as sugar (sucrose), isomaltulose, inulin, erythritol, starches and some dextrins may be used. Combinations of any of the above edible additive bulking agents may also be used in the present invention.

Edible additive bulking agents may include sugars, sugar alcohols, and combinations thereof. Sugar bulking agents generally include saccharide-containing components commonly known in the chewing gum art, including, but not limited to, sucrose, dextrose, maltose, dextrin, dried invert sugar, fructose, levulose, galactose, corn syrup solids, and the like, alone or in combination in non-sugarless chewing gums. In sugarless gums, sugar alcohols such as sorbitol, maltitol, erythritol, isomalt, mannitol, xylitol, and combinations thereof are substituted for sugar bulking agents.

Bulking agents preferably constitute from about 5 wt % to about 95 wt % of the total weight of chewing gum, more specifically from about 20 wt % to about 80 wt % and, more preferably, from about 30 wt % to about 70 wt % of the total weight of chewing gum.

If desired, it is possible to reduce or eliminate the edible additive bulking agent to provide a reduced calorie or calorie-free chewing gum. In such embodiments, the gum base may comprise up to about 98 wt % of the chewing gum, or a low caloric edible additive bulking agent can be used. Examples of low caloric bulking agents include, but are not limited to, isomalt, lactitol, maltitol, mannitol, neotame, polydextrose, sorbitol, tagatose, xylitol, polydextrose; Raftilose; Raftilin; fructooligosaccharides (NutraFlora®); Palatinose oligosaccharide; Guar Gum Hydrolysate (Sun Fiber®); or indigestible dextrin (Fibersol®), or the like.

A water-insoluble gum base constitutes approximately 5 wt % to about 98 wt % of the chewing gum of this invention; more commonly, the gum base comprises 10 wt % to about 75 wt % of the chewing gum of this invention; and in some preferred embodiments, 15 wt % to about 65 wt % of such chewing gum.

In some embodiments, combinations of the low caloric edible additive bulking agents may be used. The caloric content of a chewing gum can also be reduced by increasing the relative level of gum base while reducing the level of caloric sweeteners in the product. This can be done with or without an accompanying decrease in piece weight.

In some embodiments, at least one edible additive, such as a natural high intensity sweetener, may be a constituent of the chewing gum. Natural high intensity sweeteners can be used alone, or in combination, and include, but are not limited to, brazzein, curculin, glycyrrhizin, luo han guo (also known as monk fruit), miraculin, monellin, pentadin, rebaudioside, stevia and its glycosides, thaumatin, and the like.

In some embodiments, at least one edible additive, such as an non-natural high intensity sweetener can be used alone or in combination. Non-natural high intensity sweeteners include, but are not limited to, sucralose, aspartame, salts of acesulfame, alitame, neotame, saccharin and its salts, cyclamic acid and its salts, and the like.

In some embodiments, at least one edible additive, such as natural sweetener syrup may be a constituent of the chewing gum. Natural sweetener syrups may be used alone, or in combination, and include, but are not limited to, agave syrup, barley malt syrup, brown rice syrup, blackstrap molasses, cane juice, coconut palm sugar, honey, maple syrup, palm sugar, sorghum syrup, yacon syrup, and the like.

In some embodiments, the edible additive bulking agent sweetener, natural high intensity sweeter, non-natural high intensity sweetener, and natural sweetener syrups may be used alone or in any combination(s). In order to provide longer lasting sweetness and flavor perception, it may be desirable to encapsulate or otherwise control the timing of release of at least a portion of the high intensity sweetener. Techniques such as wet granulation, wax granulation, spray drying, spray chilling, fluid bed coating, coacervation, and fiber extrusion may be used to achieve the desired timed release characteristics.

In some embodiments, an edible additive, such as a fruit or vegetable preserve, fruit or vegetable jam, fruit or vegetable jelly, or minimally processed plant material may be a constituent of the chewing gum. Any of these may be used alone or in combination. Minimally processed plant material includes, but is not limited to, a spice, seed, fruit, vegetable, edible flower, edible leaf, edible plant, or herb, as examples. The minimally processed plant material can be processed by at least one of candying, air drying, freeze drying, dehydrating, infusion, comminuting, steaming, boiling, or the like, or by any combination thereof.

A variety of minimally processed plant materials may be used for a variety of reasons. The minimally processed plant materials may also be selected to allow marketing claims to be used in association with the chewing gums. That is, if it is desirable to promote a chewing gum as having medicinal benefits, minimally processed plant materials including, but not limited to, dandelion root or strawberry flowers, for example, may be used. Minimally processed plant materials have an intact cellular structure which may or may not be pulverized into a powder.

Usage level of the edible additive sweetener will vary greatly and will depend on such factors as potency of the sweetener, rate of release, desired sweetness of the product, level and type of flavor used, cost considerations, etc. Generally speaking, usage levels of high intensity sweeteners may vary from about 0.02 wt % to about 20 wt %. When encapsulated sweetener(s) are used, the usage level is proportionately higher.

In some embodiments, edible additives, such as a natural or non-natural flavoring agents, may be used in any number or combination, as desired. Flavoring agents may include essential oils, natural extracts, synthetic flavors or mixtures thereof including, but not limited to, oils derived from plants and fruits such as citrus oils, fruit essences, peppermint oil, spearmint oil, other mint oils, clove oil, oil of wintergreen, anise, and the like, for example.

Non-natural flavoring agents and other components may also be used. Sensate components which impart a perceived tingling or thermal response while chewing, such as a cooling or heating effect, also may be included. Such other components may include cyclic and acyclic carboxamides, menthol and menthol derivatives such as menthyl esters of food, acceptable acids, and capsaicin, among others. Acidulants may be included to impart tartness. Sensates and acidulants may be either natural or non-naturally derived.

The desired flavoring agent(s) may be used in amounts of from approximately 0.1 wt % to about 15 wt % of the chewing gum, and preferably, from about 0.2 wt % to about 5 wt %.

Water-soluble softeners, which may also be known as water-soluble plasticizers, plasticizing agents, binders or binding agents, generally constitute between approximately 0 wt % to about 30 wt % of the chewing gum, and more preferably 5 wt % to 10 wt % of the chewing gum. Water-soluble softeners may include glycerin, lecithin, wax, and any combinations thereof. If lecithin is used as the water-soluble softener, it preferably constitutes between approximately 0 wt % to 8 wt %, and more preferably between 1 wt % and 4 wt % of the chewing gum.

Syrups or high-solids solutions of sugars and/or sugar alcohols such as sorbitol solutions, hydrogenated starch hydrolysates (HSH), corn syrup and combinations thereof, may also be used. In the case of sugar gums, corn syrups and other dextrose syrups (which contain dextrose and significant amounts of higher saccharides) are most often employed. These include syrups of various DE levels including high-maltose syrups and high fructose syrups. In some cases, low-moisture syrups can replace some or all of the bulking agents used, in which case usage levels of the syrup may extend up to 50 wt % or more of the total chewing gum composition. In the case of sugarless products, solutions of sugar alcohols including sorbitol solutions and hydrogenated starch hydrolysate syrups are known to be used.

Also useful are syrups such as those disclosed in U.S. Pat. No. 5,651,936 and in U.S. Patent Publication No. 2004-234648 which are incorporated herein by reference. Such syrups serve to soften the initial chew of the product, reduce crumbliness and brittleness and increase flexibility in stick and tab products. They may also control moisture gain or loss and provide a degree of sweetness depending on the particular syrup employed.

A wide variety of gum base and chewing gum formulations including the natural elastomer or natural elastomer systems and edible additives of the present invention may be created and/or used. In some embodiments, the present invention provides for gum base formulations which are natural gum bases that include wax or those that are wax-free.

In some embodiments, the present invention provides for chewing gum formulations that can be low or high moisture formulations containing low or high amounts of moisture-containing syrup. Low moisture chewing gum formulations are those which contain less than 1.5 wt %, or less than 1 wt′Yo, or even less than 0.5 wt % water. Conversely, high moisture chewing gum formulations are those which contain more than 1.5 wt %, or more than 2 wt %, or even more than 2.5% water. The natural elastomer or natural elastomer system of the present invention can be used in sugar-containing chewing gums, and also in low sugar and non-sugar containing chewing gum formulations made with high intensity sweeteners and bulk sweeteners such as sorbitol, mannitol, other polyols (sugar alcohols), and non-sugar carbohydrates.

In some embodiments, the natural elastomer or natural elastomer system of the present invention may be used as the sole elastomer. In other embodiments it will be combined with other elastomers or elastomer systems for use in chewing gum bases. Such other elastomers, where used, include other natural elastomer(s) or natural elastomer system(s) and synthetic elastomers including polyisobutylene, isobutylene-isoprene copolymers, styrene-butadiene copolymers, polyisoprene and polyvinylacetate, among others. Natural elastomer or natural elastomer system that may be used include, but are not limited to, caoutchouc, caspi, couma macrocarpa (also called leche caspi or sorva), lechi, loquat (also called nispero), tunu, natural rubber (Hevea), jelutong, gutta, chicle, guayule, perillo, massaranduba balata, massaranduba chocolate, nispero, rosindinha, spruce gum, mastic gum, taraxacum kok-saghyz (TKS), in addition to other natural gum bases as listed in US 21 C.F.R. 172.615.

In some embodiments, the natural elastomer or natural elastomer system of the present invention may be combined with softeners, fillers, colors, antioxidants and other conventional gum base components. In some embodiments, the natural elastomer system gum base may be used to replace conventional polymer gum bases in chewing gum formulas which additionally contain edible additives, such as water-soluble bulking agents, flavors, natural and non-natural high-intensity sweeteners, colors, pharmaceutical or nutraceutical agents, minimally processed plant material, fruit or vegetable preserves, fruit or vegetable jams and jellies, and other optional edible ingredients. These chewing gums may be formed into sticks, tabs, tapes, coated or uncoated pellets or balls or any other desired form. By substituting the natural elastomer system of the present invention for a portion or all of the conventional gum base elastomers, consumer-acceptable chewing gum products may be manufactured.

A characteristic gum base useful in this invention includes about 5 to 100 wt % natural elastomer system, 0 to 20 wt % synthetic elastomer, about 0 to about 40% by weight natural elastomer, about 0 to about 35 wt % filler, about 0 to about 35 wt % softener, and optional small amounts (e.g., about 1 wt % or less) of miscellaneous ingredients such as colorants, antioxidants, and the like, which may be naturally or synthetically derived.

Further, a representative gum base generally includes 0 wt % to 30 wt. %, more particularly 5 wt. % to 10 wt % softener. Small amounts (e.g., up to about 1 wt %) of miscellaneous ingredients such as colorants, antioxidants, and the like also may be included into such a gum base.

In another embodiment, a chewing gum base of the present invention contains about 0 wt % to about 35 wt % filler and about 2 wt % to about 35 wt % softener, and optional small amounts (about 1 wt % or less) of miscellaneous ingredients such as colorants, antioxidants, and the like.

Additional elastomers may be added to the chewing gum, and may include, but are not limited to, polyisobutylene having a viscosity average molecular weight of about 100,000 to about 800,000, isobutylene-isoprene copolymer (butyl elastomer), polyolefin thermoplastic elastomers such as ethylene-propylene copolymer and ethylene-octene copolymer, styrene-butadiene copolymers having styrene-butadiene ratios of about 1:3 to about 3:1 and/or polyisoprene, or combinations thereof.

The natural elastomer or natural elastomer system component of gum bases disclosed herein may be up to 100 wt % of the gum base. In some embodiments, the natural elastomer or natural elastomer system component may be combined with compatible plasticizers and/or softeners, which may be used as the sole components of a gum base. Alternatively, mixtures of natural elastomers or natural elastomer systems and synthetic elastomers also may be used.

In some embodiments, mixtures with synthetic (conventional) elastomeric components of gum bases may comprise at least 1 wt % conventional (synthetic) elastomer. In other embodiments, at least 30 wt % and preferably at least 50 wt % of the conventional elastomer may be used. Due to cost limitations, processing requirements, sensory properties and other considerations, it may be desirable to limit the natural elastomer system component of the gum base to no more than 90 wt %, or no more than 75 wt %, or no more than 50 wt % of the gum base.

In some embodiments, mixtures of the natural elastomer or natural elastomer system with synthetic (conventional) elastomeric components of gum bases may comprise less than 70 wt % synthetic elastomer.

Additionally, a gum base may include fillers/texturizers and softeners/emulsifiers. Softeners (including emulsifiers) are added in order to optimize the chewability and mouth feel of the chewing gum.

Softeners/emulsifiers that most often are used include tallow, hydrogenated tallow, hydrogenated and partially hydrogenated vegetable oils, cocoa butter, mono- and di-glycerides such as glycerol monostearate, glycerol triacetate, lecithin, paraffin wax, microcrystalline wax, beeswax, other natural waxes and combinations or blends thereof. Lecithin and mono- and di-glycerides also function as emulsifiers to improve compatibility between the various gum base components.

Fillers/texturizers characteristically are inorganic, water-insoluble powders such as magnesium and calcium carbonate, ground limestone, silicate types such as magnesium and aluminum silicate, clay, alumina, talc, titanium oxide, mono-, di- and multi-calcium phosphate and calcium sulfate. Insoluble organic fillers including cellulose polymers such as wood as well as combinations of any of these also may be used.

Selection of various components of chewing gum bases or chewing gum formulations as disclosed herein are dictated by factors, including for example the desired properties (e.g., physical (mouthfeel), taste, odor, and the like) and/or applicable regulatory requirements (e.g., in order to have a food grade product, food grade components, such as food grade approved oils like vegetable oil, may be used.)

Colorants and whiteners may include FD&C-type dyes and lakes, fruit and vegetable extracts, titanium dioxide, and combinations thereof.

Antioxidants such as tocopherols (i.e. vitamin E), BHA, BHT, propyl gallate, and other food acceptable antioxidants may be employed to prevent oxidation of fats, oils and elastomers in the gum base.

As noted above, the base may include wax or be wax-free. An example of a wax-free gum base is disclosed in U.S. Pat. No. 5,286,500, the disclosure of which is incorporated herein by reference.

In addition to a water-insoluble gum base portion, a typical chewing gum composition includes at least one edible additive in the water-soluble portion of the chewing gum. The edible additive can be a bulk sweetener (bulking agent) and at least one flavoring agent. The water-soluble portion can include high intensity sweeteners, binders, flavoring agents (which may be water insoluble), water-soluble softeners, gum emulsifiers, colorants, acidulants, fillers, antioxidants, and other components which provide desired attributes.

Preferably, an edible additive such as a bulking agent or bulk sweetener will be useful in the subject chewing gums to provide sweetness, bulk and texture to the product. Bulking agents include sugars, sugar alcohols, and combinations thereof. Bulking agents typically constitute from about 5 wt % to about 95 wt % of the chewing gum, more particularly from about 20 wt % to about 80 wt % and, still more particularly, from about 30 wt % to about 70 wt % of the gum. Sugar bulking agents generally include saccharide containing components commonly known in the chewing gum art, including, but not limited to, sucrose, dextrose, maltose, dextrin, dried invert sugar, fructose, levulose, galactose, corn syrup solids, and the like, alone or in any combination. In sugarless gums, sugar alcohols such as sorbitol, maltitol, erythritol, isomalt, mannitol, xylitol and combinations thereof are substituted for sugar bulking agents. Combinations of sugar and sugarless bulking agents may also be used.

In addition to the above edible additive bulk sweeteners, chewing gums comprise an edible additive binder/softener in the form of a natural sweetener syrup or high-solids solution of sugars and/or sugar alcohols. In the case of sugar gums, corn syrups and other dextrose syrups (which contain dextrose and significant amounts of higher saccharides) are most commonly employed. These include syrups of various DE levels including high-maltose syrups and high fructose syrups. In the case of sugarless products, solutions of sugar alcohols including sorbitol solutions and hydrogenated starch hydrolysate syrups are commonly used. Also useful are syrups such as those disclosed in U.S. Pat. No. 5,651,936 and US Patent Publication No. 2004-234648, the teachings of which are incorporated herein by reference. Such syrups serve to soften the initial chew of the product, reduce crumbliness and brittleness and increase flexibility in stick and tab products. They may also control moisture gain or loss and provide a degree of sweetness depending on the particular syrup employed. In the case of syrups and other aqueous solutions, it is generally desirable to use a minimum practical level of water in the solution necessary to keep the solution free-flowing at acceptable handling temperatures. The usage level of such syrups and solutions should be adjusted to limit total moisture in the chewing gum to less than 3 wt %, preferably less than 2 wt % and most preferably less than 1 wt %.

Combinations of edible additive sweeteners such sugar and/or sugarless sweeteners may be used in chewing gum. Additionally, the softener may also provide additional sweetness such as with aqueous sugar or alditol solutions.

In addition to typical chewing gum components, the subject chewing gums may include active agents such as dental health actives such as minerals, nutritional supplements such as vitamins, health promoting actives such as antioxidants, for example, resveratrol, stimulants such as caffeine or theobromine, medicinal compounds, flavonoids and other such additives. These active agents may be added neat to the gum mass or encapsulated using known means to prolong release and/or prevent degradation. The actives may be added to coatings, rolling compounds and liquid or powder fillings where such are present.

The chewing gums disclosed herein are amenable to a variety of processes for manufacturing chewing gum including batch mixing, continuous mixing and tableted gum processes.

Chewing gum bases of the present invention may be easily prepared by preparing the natural elastomer system as described in U.S. Pat. Nos. 195,578 and 907,748, both incorporated by reference therefrom as if fully restated herein. Combining the natural elastomer system with any desired additional ingredients such as softeners, plastic resins, emulsifiers, fillers, colors and antioxidants as desired, may be performed by conventional batch mixing processes or continuous mixing processes. Process temperatures are generally from about 60° C. to about 130° C. in the case of a batch process. To produce the natural gum base, the natural elastomer or natural elastomer system is first compounded. Compounding involves combining the natural elastomer system with filler and elastomer plasticizer, if filler and elastomer plasticizer are needed. This compounding step generally requires long mixing times (30 to 160 minutes) to produce a homogeneous mixture. After compounding, additional filler and elastomer plasticizer are added followed by softeners while mixing to homogeneity after each edible ingredient is added. Small amount or minor ingredients such as antioxidants and color may be added at any time in the process. Whether the natural elastomer system is used alone or in combination with conventional (synthetic) elastomers, the completed base is then extruded or cast into any desirable shape (e.g., pellets, sheets or slabs) and allowed to cool and solidify.

Alternatively, continuous processes using mixing extruders, which are generally known in the art, may be used to prepare the gum base. In a continuous mixing process, initial ingredients (including ground elastomer, if used) are metered continuously into extruder ports at various points along the length of the extruder corresponding to the batch processing sequence. After the initial ingredients have massed homogeneously and have been sufficiently compounded, the balance of the base ingredients are metered into ports or injected at various points along the length of the extruder. Any remainder of elastomer component or other components are added after the initial compounding stage. The composition is then further processed to produce a homogeneous mass before discharging from the extruder outlet.

Exemplary methods of extrusion, which may optionally be used in conjunction with the present invention, include the following, the entire contents of each being incorporated herein by reference: (i) U.S. Pat. No. 6,238,710 claims a method for continuous chewing gum base manufacturing, which entails compounding all ingredients in a single extruder; (ii) U.S. Pat. No. 6,086,925 discloses the manufacture of chewing gum base by adding a hard elastomer, a filler and a lubricating agent to a continuous mixer; (iii) U.S. Pat. No. 5,419,919 discloses continuous gum base manufacture using a paddle mixer by selectively feeding different ingredients at different locations on the mixer; and, (iv) U.S. Pat. No. 5,397,580 discloses continuous gum base manufacture wherein two continuous mixers are arranged in series and the blend from the first continuous mixer is continuously added to the second mixer.

Chewing gum is generally manufactured by sequentially adding the various chewing gum ingredients to commercially available mixers known in the art. After the ingredients have been thoroughly mixed, the chewing gum mass is discharged from the mixer and shaped into the desired form, such as by rolling into sheets and cutting into sticks, tabs or pellets or by extruding and cutting into chunks.

Generally, the ingredients are mixed by first softening or melting the gum base and adding it to a running mixer. The gum base may alternatively be softened or melted in the mixer. Color and emulsifiers also may be added at this time.

A chewing gum softener such as lecithin may be added next along with part of the bulk portion. Further parts of the bulk portion may then be added to the mixer. Flavoring agents are most often added with the final part of the bulk portion. The entire mixing process usually takes from about five to about fifteen minutes, although longer mixing times are sometimes required.

In yet another alternative methodology, it may be possible to prepare the gum base and chewing gum in a single high-efficiency extruder as disclosed in U.S. Pat. No. 5,543,160. Chewing gums of the present invention may be prepared by a continuous process comprising the steps of: a) adding gum base ingredients into a high efficiency continuous mixer; b) mixing the ingredients to produce a homogeneous gum base, c) adding at least one sweetener and at least one flavor into the continuous mixer, and mixing the sweetener and flavor with any remaining ingredients to form a chewing gum product; and d) discharging the mixed chewing gum mass from the single high efficiency continuous mixer.

Of course, many variations on the basic gum base and chewing gum mixing processes are possible and the examples provided should not be construed as limiting.

After mixing, the chewing gum mass may be formed, for example by rolling or extruding into any desired shape such as sticks, tabs, chunks or pellets. The product may also be filled (for example with a liquid syrup or a powder) and/or coated, for example, with a hard sugar or polyol coating.

After forming, and optionally filling and/or coating, the product will typically be packaged in appropriate packaging materials. The purpose of the packaging is to keep the product clean, protect it from environmental elements such as oxygen, moisture and light and to facilitate branding and retail marketing of the product. Unless otherwise specified, all percentages are by weight of the specified composition.

### Examples

The following examples and comparative run illustrate certain aspects and embodiments of the present invention, but do not limit the invention described and claimed. Amounts listed are in weight percent, based upon the total weight of the gum base, or chewing gum, as the case may be.

Gum base formulas using at least one natural elastomer or natural elastomer system are shown in Examples 1-24 in Tables 1-3.

TABLE 1

| Wt. % | Ex. 1 | Ex. 2 | Ex. 3 | Ex. 4 | Ex. 5 | Ex. 6 | Ex. 7 | Ex. 8 |
|---|---|---|---|---|---|---|---|---|
| Chicle | 100.00 | 78.94 | 90.00 | 88.95 | 80.90 | 70.00 | 60.00 | 50.00 |
| Jelutong | 0.00 | 20.00 | 0.00 | 0.00 | 0.00 | 12.00 | 5.00 | 20.00 |
| Sorva | 0.00 | 0.00 | 0.00 | 0.00 | 0.00 | 0.00 | 5.00 | 10.00 |
| Guayule | 0.00 | 0.00 | 0.00 | 0.00 | 0.00 | 0.00 | 0.00 | 0.00 |
| Beeswax Wax | 0.00 | 0.00 | 0.00 | 0.00 | 0.00 | 0.00 | 5.00 | 5.00 |
| Candela Wax | 0.00 | 0.00 | 8.00 | 10.00 | 15.00 | 12.00 | 10.00 | 5.00 |
| Carnauba Wax | 0.00 | 0.00 | 1.98 | 0.00 | 0.00 | 0.00 | 4.92 | 5.00 |
| Calcium Carbonate | 0.00 | 0.00 | 0.00 | 0.00 | 0.00 | 0.00 | 0.00 | 0.00 |
| Talc | 0.00 | 0.00 | 0.00 | 0.00 | 0.00 | 0.00 | 0.00 | 0.00 |
| Lecithin | 0.00 | 0.98 | 0.00 | 1.00 | 2.00 | 0.50 | 1.98 | 1.30 |
| Hydrogenated Veg. oil | 0.00 | 0.00 | 0.00 | 0.00 | 2.00 | 5.45 | 8.00 | 3.67 |
| Vitamin E | 0.00 | 0.08 | 0.02 | 0.05 | 0.10 | 0.05 | 0.10 | 0.03 |
| Total | 100.00 | 100.00 | 100.00 | 100.00 | 100.00 | 100.00 | 100.00 | 100.00 |

TABLE 2

| wt. % | Ex. 9 | Ex. 10 | Ex. 11 | Ex. 12 | Ex. 13 | Ex. 14 | Ex. 15 | Ex. 16 |
|---|---|---|---|---|---|---|---|---|
| Chicle | 75.00 | 50.00 | 75.00 | 50.00 | 75.00 | 5.00 | 40.00 | 5.00 |
| Jelutong | 0.00 | 0.00 | 0.00 | 0.00 | 0.00 | 60.00 | 25.00 | 10.00 |
| Sorva | 0.00 | 0.00 | 0.00 | 0.00 | 0.00 | 0.00 | 25.00 | 70.00 |
| Guayule | 0.00 | 0.00 | 0.00 | 0.00 | 0.00 | 0.00 | 0.00 | 0.00 |
| Beeswax Wax | 0.00 | 0.00 | 0.00 | 0.00 | 0.00 | 0.00 | 0.00 | 0.00 |
| Candela Wax | 15.00 | 30.00 | 15.00 | 30.00 | 10.00 | 0.00 | 9.90 | 15.00 |
| Carnauba Wax | 0.00 | 0.00 | 0.00 | 0.00 | 0.00 | 10.00 | 0.00 | 0.00 |
| Calcium Carbonate | 0.00 | 0.00 | 10.00 | 20.00 | 0.00 | 15.00 | 0.00 | 0.00 |
| Talc | 10.00 | 20.00 | 0.00 | 0.00 | 10.00 | 0.00 | 0.00 | 0.00 |
| Lecithin | 0.00 | 0.00 | 0.00 | 0.00 | 0.00 | 0.00 | 0.00 | 0.00 |
| Hydrogenated Veg. oil | 0.00 | 0.00 | 0.00 | 0.00 | 5.00 | 10.00 | 0.00 | 0.00 |
| Vitamin E | 0.00 | 0.00 | 0.00 | 0.00 | 0.00 | 0.00 | 0.10 | 0.00 |
| Total | 100.00 | 100.00 | 100.00 | 100.00 | 100.00 | 100.00 | 100.00 | 100.00 |

TABLE 3

| wt. % | Ex. 17 | Ex. 18 | Ex. 19 | Ex. 20 | Ex. 21 | Ex. 22 | Ex. 23 | Ex. 24 |
|---|---|---|---|---|---|---|---|---|
| Chicle | 0.00 | 0.00 | 25.00 | 15.00 | 50.00 | 45.00 | 10.00 | 20.00 |
| Jelutong | 0.00 | 0.00 | 10.00 | 0.00 | 0.00 | 0.00 | 20.00 | 0.00 |
| Sorva | 0.00 | 0.00 | 0.00 | 0.00 | 5.00 | 15.00 | 10.00 | 0.00 |
| Guayule | 85.00 | 70.00 | 50.00 | 80.00 | 25.00 | 40.00 | 35.00 | 65.00 |
| Beeswax Wax | 0.00 | 0.00 | 0.00 | 0.00 | 0.00 | 0.00 | 5.00 | 10.00 |
| Candela Wax | 7.00 | 20.00 | 5.00 | 5.00 | 12.00 | 0.00 | 0.00 | 0.00 |
| Carnauba Wax | 0.00 | 0.00 | 0.00 | 0.00 | 0.00 | 0.00 | 0.00 | 0.00 |
| Calcium Carbonate | 8.00 | 10.00 | 0.00 | 0.00 | 0.00 | 0.00 | 0.00 | 5.00 |
| Talc | 0.00 | 0.00 | 5.00 | 0.00 | 5.90 | 0.00 | 0.00 | 0.00 |
| Lecithin | 0.00 | 0.00 | 0.00 | 0.00 | 2.00 | 0.00 | 0.00 | 0.00 |
| Hydrogenated Veg. oil | 0.00 | 0.00 | 5.00 | 0.00 | 0.00 | 0.00 | 20.00 | 0.00 |
| Vitamin E | 0.00 | 0.00 | 0.00 | 0.00 | 0.10 | 0.00 | 0.00 | 0.00 |
| Total | 100.00 | 100.00 | 100.00 | 100.00 | 100.00 | 100.00 | 100.00 | 100.00 |

Chewing gums (Examples 25-64) may be made according to the formulas in Tables 4-9 incorporating the gum bases as shown in Tables 1-3.

TABLE 4

| | Ex. | Ex. | Ex. | Ex. | Ex. | Ex. | Ex. | Ex. |
|---|---|---|---|---|---|---|---|---|
| | 25 | 26 | 27 | 28 | 29 | 30 | 31 | 32 |
| Gum Base Example | 1-24 | 1-24 | 1-24 | 1-24 | 1-24 | 1-24 | 1-24 | 1-24 |
| Gum Base (wt. %) | 99.00 | 98.00 | 97.50 | 95.00 | 90.00 | 90.00 | 85.00 | 85.00 |
| Natural High Intensity Sweetener | 0.00 | 0.00 | 2.50 | 1.99 | 0.00 | 0.00 | 0.00 | 0.75 |
| (wt. %) | | | | | | | | |
| Bulking Agent Sweetener (wt. %) | 0.00 | 0.00 | 0.00 | 0.00 | 0.00 | 0.00 | 12.70 | 1.35 |
| Non-natural High Intensity | 0.00 | 0.00 | 0.00 | 0.00 | 0.00 | 0.00 | 0.00 | 0.75 |
| Sweetener (wt. %) | | | | | | | | |
| Natural Sweetener Syrup (wt. %) | 0.00 | 0.00 | 0.00 | 0.00 | 10.00 | 5.00 | 0.00 | 3.00 |
| Filler (wt. %) | 0.00 | 0.00 | 0.00 | 0.00 | 0.00 | 0.00 | 0.00 | 0.00 |
| Minimally Processed Plant Material | 1.00 | 2.00 | 0.00 | 2.00 | 0.00 | 3.45 | 2.00 | 6.00 |
| (wt. %) | | | | | | | | |
| Color (wt. %) | 0.00 | 0.00 | 0.00 | 0.01 | 0.00 | 0.05 | 0.20 | 0.40 |
| Flavor (wt. %) | 0.00 | 0.00 | 0.00 | 1.00 | 0.00 | 1.50 | 0.10 | 1.75 |
| Acid (wt. %) | 0.00 | 0.00 | 0.00 | 0.00 | 0.00 | 0.00 | 0.00 | 1.00 |
| Total (wt. %) | 100.00 | 100.00 | 100.00 | 100.00 | 100.00 | 100.00 | 100.00 | 100.00 |

TABLE 5

| | Ex. | Ex. | Ex. | Ex. | Ex. | Ex. | | Ex. |
|---|---|---|---|---|---|---|---|---|
| | 33 | 34 | 35 | 36 | 37 | 38 | Ex. 39 | 40 |
| Gum Base Example | 1-24 | 1-24 | 1-24 | 1-24 | 1-24 | 1-24 | 1-24 | 1-24 |
| Gum Base (wt. %) | 80.00 | 75.00 | 70.00 | 65.00 | 60.00 | 55.00 | 50.00 | 45.00 |
| Natural High Intensity Sweetener | 0.00 | 0.00 | 1.00 | 1.50 | 0.00 | 1.00 | 0.50 | 0.75 |
| (wt. %) | | | | | | | | |
| Bulking Agent Sweetener (wt. %) | 7.23 | 13.45 | 0.00 | 1.49 | 0.00 | 11.00 | 20.85 | 27.20 |
| Non-natural High Intensity | 0.00 | 0.00 | 1.00 | 0.00 | 3.00 | 1.00 | 0.25 | 1.50 |
| Sweetener (wt. %) | | | | | | | | |
| Natural Sweetener Syrup (wt. %) | 10.00 | 10.00 | 12.48 | 30.00 | 28.75 | 23.70 | 20.00 | 15.00 |
| Filler (wt. %) | 1.00 | 0.00 | 5.00 | 0.00 | 0.00 | 2.00 | 2.00 | 2.00 |
| Minimally Processed Plant Material | 1.00 | 1.00 | 7.00 | 2.00 | 7.00 | 4.00 | 3.00 | 6.25 |
| (wt. %) | | | | | | | | |
| Color (wt. %) | 0.02 | 0.05 | 0.02 | 0.01 | 0.00 | 0.80 | 0.20 | 0.40 |
| Flavor (wt. %) | 0.75 | 0.50 | 1.50 | 0.00 | 0.00 | 0.75 | 3.00 | 1.25 |
| Acid (wt. %) | 0.00 | 0.00 | 2.00 | 0.00 | 1.25 | 0.75 | 0.20 | 0.65 |
| Total (wt. %) | 100.00 | 100.00 | 100.00 | 100.00 | 100.00 | 100.00 | 100.00 | 100.00 |

TABLE 6

| | Ex. 41 | Ex. 42 | Ex. 43 | Ex. 44 | Ex. 45 | Ex. 46 | Ex. 47 | Ex. 48 |
|---|---|---|---|---|---|---|---|---|
| Gum Base Example | 1-24 | 1-24 | 1-24 | 1-24 | 1-24 | 1-24 | 1-24 | 1-24 |
| Gum Base (wt. %) | 40.00 | 35.00 | 30.00 | 25.00 | 20.00 | 95.30 | 92.75 | 87.10 |
| Natural High Intensity Sweetener (wt. %) | 0.50 | 0.00 | 1.00 | 1.50 | 0.50 | 0.00 | 0.50 | 0.00 |
| Bulking Agent Sweetener (wt. %) | 46.24 | 52.20 | 38.98 | 67.54 | 31.90 | 0.00 | 0.00 | 0.00 |
| Non-natural High Intensity Sweetener (wt. | 0.00 | 0.00 | 1.00 | 1.50 | 0.00 | 0.00 | 1.00 | 1.50 |
| %) | | | | | | | | |
| Natural Sweetener Syrup (wt. %) | 10.00 | 10.00 | 15.00 | 0.00 | 40.00 | 0.00 | 0.00 | 3.50 |
| Filler (wt. %) | 1.00 | 0.75 | 5.00 | 1.25 | 1.00 | 0.00 | 0.00 | 0.00 |
| Minimally Processed Plant Material (wt. %) | 1.00 | 1.00 | 8.00 | 2.00 | 4.00 | 2.50 | 3.50 | 5.00 |
| Color (wt. %) | 0.06 | 0.05 | 0.02 | 0.01 | 0.00 | 0.80 | 0.20 | 0.40 |
| Flavor (wt. %) | 1.20 | 0.90 | 0.80 | 1.10 | 1.80 | 1.00 | 1.45 | 2.00 |
| Acid (wt. %) | 0.00 | 0.10 | 0.20 | 0.10 | 0.80 | 0.40 | 0.60 | 0.50 |
| Total (wt. %) | 100.00 | 100.00 | 100.00 | 100.00 | 100.00 | 100.00 | 100.00 | 100.00 |

TABLE 7

| | Ex. 49 | Ex. 50 | Ex. 51 | Ex. 52 | Ex. 53 | Ex. 54 | Ex. 55 | Ex. 56 |
|---|---|---|---|---|---|---|---|---|
| Gum Base Example | 1-24 | 1-24 | 1-24 | 1-24 | 1-24 | 1-24 | 1-24 | 1-24 |
| Gum Base (wt. %) | 75.00 | 55.00 | 68.10 | 40.25 | 15.00 | 32.75 | 45.00 | 50.00 |
| stevia or luo han guo (wt. %) | 0.00 | 0.00 | 1.50 | 1.50 | 1.00 | 0.00 | 0.50 | 0.00 |
| Sugar or Sorbitol (wt. %) | 8.00 | 23.00 | 0.00 | 53.34 | 52.71 | 23.79 | 32.70 | 38.08 |
| Xylitol or Sucralose (wt. %) | 0.00 | 0.00 | 1.00 | 0.00 | 0.50 | 0.00 | 1.00 | 1.50 |
| Honey or Agave Syrup (wt. %) | 14.84 | 20.00 | 14.00 | 0.00 | 30.00 | 40.00 | 16.00 | 3.50 |
| Calcium Carbonate (wt. %) | 1.00 | 0.00 | 5.00 | 1.00 | 0.00 | 0.00 | 0.00 | 0.02 |
| Edible Leaves (wt. %) | 1.00 | 1.00 | 8.00 | 2.00 | 0.50 | 2.50 | 3.50 | 5.00 |
| Color (wt. %) | 0.06 | 0.05 | 0.40 | 0.06 | 0.04 | 0.80 | 0.20 | 0.40 |
| Flavor (wt. %) | 0.00 | 0.75 | 1.00 | 1.25 | 0.25 | 0.06 | 0.90 | 0.50 |
| Acid (wt. %) | 0.10 | 0.20 | 1.00 | 0.60 | 0.00 | 0.10 | 0.20 | 1.00 |
| Total (wt. %) | 100.00 | 100.00 | 100.00 | 100.00 | 100.00 | 100.00 | 100.00 | 100.00 |

TABLE 8

| | Ex. 57 | Ex. 58 | Ex. 59 | Ex. 60 | Ex. 61 | Ex. 62 | Ex. 63 | Ex. 64 |
|---|---|---|---|---|---|---|---|---|
| Gum Base Example | 1-24 | 1-24 | 1-24 | 1-24 | 1-24 | 1-24 | 1-24 | 1-24 |
| Gum Base (wt. %) | 50.00 | 28.00 | 36.00 | 33.00 | 15.00 | 41.00 | 21.00 | 44.00 |
| stevia or luo han guo (wt. %) | 0.60 | 0.00 | 1.00 | 1.50 | 0.00 | 1.50 | 0.50 | 0.00 |
| Sugar or Sorbitol (wt. %) | 11.12 | 44.01 | 37.09 | 55.89 | 0.00 | 50.27 | 46.30 | 34.77 |
| Xylitol or Sucralose (wt. %) | 1.20 | 0.00 | 1.00 | 0.00 | 0.00 | 1.50 | 1.00 | 1.50 |
| Honey or Agave Syrup (wt. %) | 30.00 | 21.00 | 15.00 | 0.00 | 10.00 | 0.00 | 24.00 | 12.57 |
| Calcium Carbonate (wt. %) | 1.00 | 0.00 | 5.00 | 0.00 | 0.00 | 0.00 | 0.00 | 0.00 |
| Fruit (wt. %) | 5.00 | 6.00 | 4.00 | 8.00 | 4.20 | 3.75 | 5.90 | 6.00 |
| Color (wt. %) | 0.06 | 0.05 | 0.05 | 0.01 | 0.00 | 0.80 | 0.30 | 0.40 |
| Flavor (wt. %) | 0.02 | 0.04 | 0.06 | 0.10 | 0.90 | 0.08 | 0.00 | 0.01 |
| Acid (wt. %) | 1.00 | 0.90 | 0.80 | 1.50 | 1.20 | 1.10 | 1.00 | 0.75 |
| Total (wt. %) | 100.00 | 100.00 | 100.00 | 100.00 | 31.30 | 100.00 | 100.00 | 100.00 |

TABLE 9

| | Ex. | Ex. | Ex. | Ex. | Ex. | Ex. | Ex. | Ex. |
|---|---|---|---|---|---|---|---|---|
| | 65 | 66 | 67 | 68 | 68 | 70 | 71 | 72 |
| Gum Base Example | 1-24 | 1-24 | 1-24 | 1-24 | 1-24 | 1-24 | 1-24 | 1-24 |
| Gum Base (wt. %) | 41.00 | 36.00 | 32.00 | 27.00 | 23.00 | 20.00 | 18.00 | 15.00 |
| Natural High Intensity Sweetener | 0.50 | 0.00 | 1.00 | 1.50 | 0.50 | 0.00 | 0.50 | 1.50 |
| (wt. %) | | | | | | | | |
| Bulking Agent Sweetener (wt. %) | 44.24 | 41.50 | 51.58 | 66.99 | 47.00 | 66.25 | 74.75 | 50.50 |
| Non-natural High Intensity | 0.00 | 0.00 | 1.00 | 0.00 | 0.90 | 2.30 | 1.00 | 1.50 |
| Sweetener (wt. %) | | | | | | | | |
| Natural Sweetener Syrup (wt. %) | 10.00 | 20.00 | 0.00 | 0.00 | 21.00 | 0.00 | 0.00 | 23.60 |
| Filler (wt. %) | 0.00 | 0.75 | 5.00 | 1.25 | 1.00 | 6.75 | 0.00 | 0.00 |
| Minimally Processed Plant Material | 3.00 | 1.00 | 8.00 | 2.00 | 4.00 | 2.50 | 3.50 | 5.00 |
| (wt. %) | | | | | | | | |
| Color (wt. %) | 0.06 | 0.05 | 0.02 | 0.06 | 0.00 | 0.80 | 0.20 | 0.40 |
| Flavor (wt. %) | 1.20 | 0.60 | 1.20 | 1.10 | 1.80 | 1.00 | 1.45 | 2.00 |
| Acid (wt. %) | 0.00 | 0.10 | 0.20 | 0.10 | 0.80 | 0.40 | 0.60 | 0.50 |
| Total (wt. %) | 100.00 | 100.00 | 100.00 | 100.00 | 100.00 | 100.00 | 100.00 | 100.00 |

1. A chewing gum comprising a gum base comprising at least one natural elastomer or natural elastomer system and at least one edible additive selected from the group consisting of minimally processed plant materials, vitamins, stimulants, natural high intensity sweeteners, menthyl esters of food acceptable acids, cyclic and acyclic carboxamide sensates, and combinations thereof.

2. The chewing gum of claim 1, wherein the natural elastomer system comprises an elastomeric polymer and an elastomer plasticizer.

3. The chewing gum of claim 1, wherein the natural elastomer or natural elastomer system is selected from the group consisting of caoutchouc, couma macrocarpa (also called leche caspi or sorva), loquat (also called nispero), tunu, jelutong, gutta, chicle, spruce gum, and mastic gum, guayule, perillo, massaranduba balata, massaranduba chocolate, nispero, rosindinha, taraxacum kok-saghyz and combinations thereof.

4. The chewing gum of claim 1, wherein the natural elastomer or natural elastomer system comprises a combination of at least two natural elastomers or natural elastomer systems.

5. The chewing gum of claim 1, wherein the edible additive comprises at least one natural high intensity sweetener.

6. The chewing gum of claim 5, wherein the at least one natural high intensity sweetener is selected from the group consisting of brazzein, curculin, qlycyrrhizin, luo han quo, miraculin, monellin, pentadin, rebaudioside, stevia, stevioside, thaumatin, and combinations.

7. The chewing gum of claim 1, wherein the edible additive is at least one minimally processed plant material.

8. The chewing gum of claim 7, wherein the minimally processed plant material is selected from the group consisting of spices, seeds, fruits, vegetables, edible flowers, edible leaves, edible plants, herbs, and combinations thereof.

9. The chewing gum of claim 7, wherein the minimally processed plant material is processed by at least one of candying, air drying, freeze drying, dehydrating, infusion, comminuting, steaming, or boiling.

10. The chewing gum of claim 1, further comprising a bulking agent sweetener selected from the group comprising sucrose, dextrose, maltose, dextrin, dried invert sugar, fructose, levulose, galactose, corn syrup solids, agave syrup, barley malt syrup, brown rice syrup, blackstrap molasses, cane juice, coconut palm sugar, honey, maple syrup, palm sugar, sorghum syrup, yacon syrup, and combinations thereof.

11. The chewing gum of claim 1, further comprising at least one natural wax, and at least one edible additive.

12. The chewing gum of claim 11, wherein the natural wax is selected from the group consisting of carnauba wax, candela wax, beeswax, and combinations thereof.

13. The chewing gum of claim 1, wherein the edible additive comprises a nutritional supplement.

14. The chewing gum of claim 13, wherein the nutritional supplement comprises a vitamin.

15. The chewing gum of claim 1, wherein the edible additive is a stimulant.

16. The chewing gum of claim 15, wherein the stimulant is selected from the group consisting of caffeine and theobromine.

17. The chewing gum of claim 1, wherein the gum base comprises about 15 wt % to about 50 wt % of the chewing gum.

18-39. (canceled)
